(19) United States
(12) Patent Application Publication
(10) Pub. No.: US 2026/0127182 A1
(43) Pub. Date: May 7, 2026

(54) RECOMMENDATION ENGINE FOR IMPROVED SEARCH AND CONTENT RECOMMENDATION CAPABILITIES

(71) Applicant: OBRIZUM GROUP LTD., Cambridge (GB)

(72) Inventors: Chibeza Chintu AGLEY, Cambridge (GB); Christopher PEDDER, Leysin (CH)

(21) Appl. No.: 19/379,484

(22) Filed: Nov. 4, 2025

Related U.S. Application Data
(60) Provisional application No. 63/716,221, filed on Nov. 4, 2024.

(51) Int. Cl. G06F 16/2457; G06F 16/2452; G06F 16/248; G06F 16/28; G06Q 50/20

(52) U.S. Cl. CPC G06F 16/24575; G06F 16/2452; G06F 16/248; G06F 16/283; G06Q 50/205

(57) ABSTRACT

In one embodiment, a computer implemented method for generating personalized search results is disclosed. The method may include processing, via a processor, a search query of a user, modifying, via the processor, the search query based on educational competency data of the user, generating, via the processor, a search result based on the modified search query by performing a search operation in a knowledge space based on the modified search query to retrieve one or more content items of the knowledge space corresponding to the modified search query, generating, via the processor, a user interface configured to display the search result; and transmitting, via the processor, the user interface to a user device associated with the user.

### CROSS-REFERENCE TO RELATED APPLICATIONS

This application claims the benefit of priority pursuant to 35 U.S.C. § 119(e) of U.S. Provisional Patent Application No. 63/716,221, filed Nov. 4, 2024, entitled “Recommendation Engine for Improved Search and Content Recommendation Capabilities,” which is hereby incorporated herein in its entirety.

### BACKGROUND

The effective design of educational curriculums requires information on the competencies and weaknesses of the student engaged with the educational curriculum. For example, educational curriculums are often designed to address educational concepts that the student has a hard time understanding in order to bolster the student's understanding for that concept. The information on the student's competencies and weaknesses are often derived from the student's engagement with the educational curriculum, e.g., as the result of tests and other assessments. Furthermore, curriculums are often impersonal lesson plans that do not address an individual student's unique needs and may not change based on the learning journey of the student. Such curriculums that do not capture the full picture of the student's competencies and weaknesses may not provide an effective learning experience for the student.

Furthermore, asking questions is a vital aspect of learning providing benefits over passive listening or viewing. As such, learning curriculums that provide only educational content for the student to consume, or educational assessments for the student to answer without providing an opportunity for the student to ask questions or search for topics of the student's curiosity may not provide an effective learning experience.

Likewise, search systems, such as online search engines, generally only generate a search result based on a search query input by a user. The search systems do not capture the context of the search query including the user's proficiency and level of understanding in concepts included in the search query. Such search systems may provide search results that do not accurately reflect the needs of the user and do not adequately answer the user's inquiry.

### BRIEF SUMMARY

In one embodiment, a computer implemented method for generating personalized search results is disclosed. The method may include processing, via a processor, a search query of a user, modifying, via the processor, the search query based on educational competency data of the user, generating, via the processor, a search result based on the modified search query by performing a search operation in a knowledge space based on the modified search query to retrieve one or more content items of the knowledge space corresponding to the modified search query, generating, via the processor, a user interface configured to display the search result; and transmitting, via the processor, the user interface to a user device associated with the user.

Optionally, in some embodiments, processing the search query includes generating an embedding vector from search terms of the search query.

Optionally, in some embodiments, the embedding vector includes a text embedding of the search terms and a text embedding of terms similar in meaning to the search terms.

Optionally, in some embodiments, the educational competency data includes learning journey data, educational content data, assessment data, and content recommendation data, and modifying the search query based on the educational competency data of the user includes retrieving a last content recommendation of a learning journey of the user, generating a text embedding of the last recent recommended content, and appending the text embedding to the search query.

Optionally, in some embodiments, the educational competency data includes learning journey data, educational content data, assessment data, and content recommendation data, and modifying the search query based on the educational competency data of the user includes retrieving a plurality of content recommendations of a learning journey of the user, generating a text embedding of the plurality of recommended content, and appending the text embedding to the search query.

Optionally, in some embodiments, appending the text embedding to the search query includes evaluating a user competency in a plurality of concepts presented in the plurality of recommended content, determining a concept with low user competency, and appending the text embedding corresponding to the concept with low user competency to the search query.

Optionally, in some embodiments, the method further includes generating a summary based on the search result, including: generating a first text portion via a large language model (LLM) utilizing a retrieval augmented generation operation to extract and summarize information of a first content item of the one or more content items, generating a second text portion via the LLM, the second text portion including a natural language response to the search query based on the one or more content items, generating a visual indicator configured to demarcate the first text portion and the second text portion, generating a citation associated with the first text portion, wherein the citation is configured to reference the first content item, and configuring the user interface to display the first text portion, the second text portion, the visual indicator, and the citation.

Optionally, in some embodiments, generating the user interface includes evaluating a user competency in a plurality of concepts presented in a learning journey, weighting the plurality of concepts such that the concepts with lower user competency are assigned a higher weight, and configuring the user interface to display a plurality of content items of the search result based on the assigned weights.

Optionally, in some embodiments, configuring the user interface to display the plurality of content items of the search result based on the assigned weight includes determining a concept presented in the plurality of content items of the search result, assigning a priority to a content item of the plurality of content items based on the concept presented in the content item, such that a content item with a concept of higher weight is assigned a higher priority, and configuring the user interface to display the content item in a ranked order based on the assigned priority.

Optionally, in some embodiments, generating the user interface includes ordering the content items of the search result based on the assigned priority of the content items, and configuring the user interface to display the content items of the search result to the user such that the content item with the highest assigned priority is displayed first to the user.

In another embodiment, a computer implemented method for generating personalized content recommendations is disclosed. The method may include simulating, via a processor, educational competency data of a user based on search data of the user, evaluating, via the processor, a user understanding of a concept based on the simulated educational competency data, generating, via the processor, a content recommendation based on the user understanding, generating, via the processor, a user interface configured to display the content recommendation; and transmitting, via the processor, the user interface to a user device associated with the user.

Optionally, in some embodiments, the search data of the user includes a search query of the user and a search result presented to the user.

Optionally, in some embodiments, the search data of the user further includes a search result browsing history of the user, where the search result browsing history includes a record of an interaction of the user with a search result.

Optionally, in some embodiments, the educational competency data includes learning journey data, educational content data, assessment data, and content recommendation data, and simulating the educational competency data of the user based on search data of the user includes generating a learning journey node based on the search data and concatenating the learning journey node to a learning journey of the user.

Optionally, in some embodiments, generating the learning journey node based on the search data includes generating a text embedding of the search data, determining a concept represented in the text embedding, and generating a learning journey node indicating low user competence in the concept.

Optionally, in some embodiments, generating the text embedding of the search data includes concatenating a text embedding of a search query with a text embedding of a search result browsed by the user.

Optionally, in some embodiments, generating the text embedding of the search data includes generating a summary of the search data using a language model and generating a text embedding of the summary.

Optionally, in some embodiments, evaluating the user understanding of the concept based on the simulated educational competency data includes employing a mathematical function such that increased frequency of search data on a first concept corresponds to a lower user understanding of the first concept.

Optionally, in some embodiments, the mathematical function is a logarithmic decay function.

Optionally, in some embodiments, generating the content recommendation based on the user understanding includes generating a recommendation for a content item corresponding to a first concept where the user understanding of the first concept is low.

### BRIEF DESCRIPTION OF THE SEVERAL VIEWS OF THE DRAWINGS

FIG. 1 illustrates an example of a computer-implemented recommendation engine system according to an embodiment of the disclosure.

FIG. 2 is a flow diagram for generating a search result based on user learning journey data with the recommendation engine system of FIG. 1 according to an embodiment of the disclosure.

FIG. 3 is a flow diagram for generating a concept node recommendation based on user search data with the recommendation engine system of FIG. 1 according to an embodiment of the disclosure.

FIG. 4 illustrates an example diagram for modifying a search query as described with respect to the method shown in FIG. 2 according to an embodiment of the disclosure.

FIG. 5 illustrates an example diagram for generating a concept node recommendation as described with respect to the method shown in FIG. 3 according to an embodiment of the disclosure.

FIG. 6 illustrates an example user interface of the recommendation engine system of FIG. 1 according to an embodiment of the disclosure.

FIG. 7 is a block diagram of an example computer system suitable for use in the recommendation engine system of FIG. 1 according to an embodiment of the disclosure.

### DETAILED DESCRIPTION

The system and methods described herein include a recommendation engine that generates a personalized learning experience based on a user's search history (e.g., via a search engine, such as a web search engine or other searching tool). In a similar manner, the recommendation engine may generate a personalized search experience for a user based on the user's educational competency, including the user's learning journey.

As used herein, a learning journey represents an educational or other informative experience provided to a user where the user engages with educational content and optionally assessments or other tracked engagements with topics or concepts. The learning journey may include a curriculum of educational content and concepts presented to the user, assessments of the user's understanding or confidence level in concepts presented in the curriculum, and recommendations for further educational content to be provided for the user. In some embodiments, user input regarding his or her own confidence levels may further be included as part of the overall understanding. For example, various input mechanisms, such as user interface sliders, icons, or numerical selections, may be presented to allow a user to not only answer the question, but also input a confidence metric on the user's confidence that the answer provided is correct. This helps to further provide data regarding a user's understanding, which can further enhance the learning experience and search functionality.

The recommendation engine generates an enhanced personalized learning experience for the user by utilizing the user's search history to generate insight on the user's competencies in educational concepts. For example, a user that frequently searches a topic in an online search engine may have a poor understanding of the topic. By evaluating the user's search history (e.g., queries), the recommendation engine may assess the user's strength and/or weakness in an educational concept and generate an educational curriculum for the user based on an improved insight of the user's understanding. The improved insight allows the recommendation engine to generate educational content for the user personalized to the user and better tailored to the user's understanding.

Additionally, by utilizing the search queries, the recommendation provides a learning experience including self-direction in the user's learning. The user is empowered to ask questions and search topics in a search system, improving the learning experience for the user.

Furthermore, in some embodiments, the recommendation engine can be configured to generate a personalized search experience by utilizing the user's learning journey to provide context to a search query input by the user into a search system. For example, a user is more likely to search for concepts recently learned or concepts that they have difficulty understanding. By evaluating concepts, the user struggles to understand and utilizing data on concepts recently presented to the user in the learning journey, the recommendation engine can generate improved search results, e.g., results personalized to the user's educational needs and more accurate to the user's query and intent. By using the user's individual usage patterns between the search system and educational system of the recommendation engine, the recommendation engine can provide both an improved educational experience and an improved search experience.

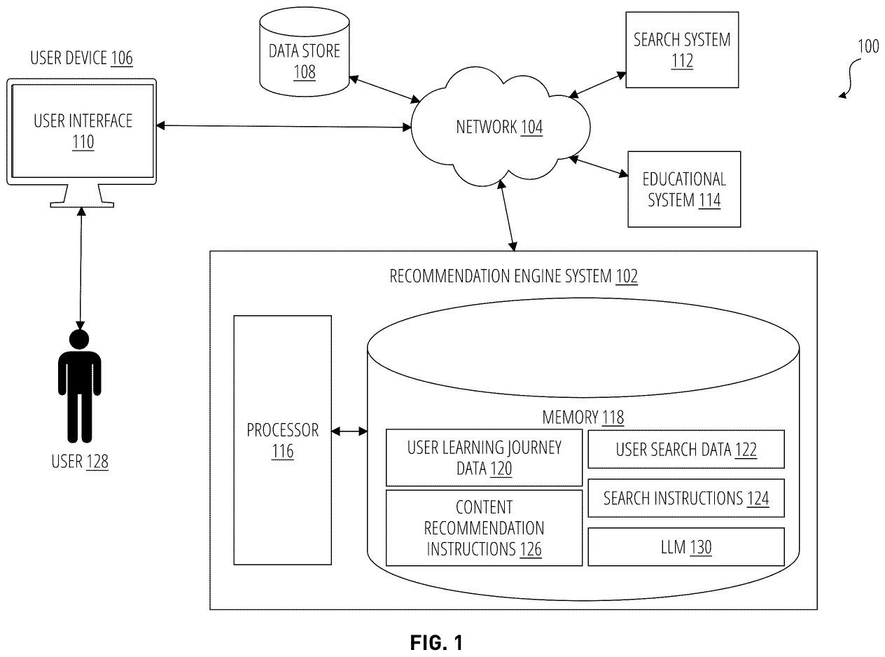

Turning now to the figures, FIG. 1 illustrates an example system 100 according to an embodiment of the disclosure. The system 100 provides a recommendation engine experience (e.g., via a software program) to a user 128 via a user device 106. The recommendation engine experience includes providing a search result to the user 128 (e.g., to the user device 106) in response to a search query input by the user 128 (e.g., at the user device 106). The search result may be generated and biased based on a learning journey of the user 128. For example, the recommendation engine experience may provide search results to the user 128 based on the most recent educational content recommended to the user 128 in the user's 128 learning journey. The recommendation engine experience additionally includes generating or modifying a learning journey based on search data of the user 128. For example, the recommendation engine experience may recommend educational content to the user 128 based on the search history of the user 128.

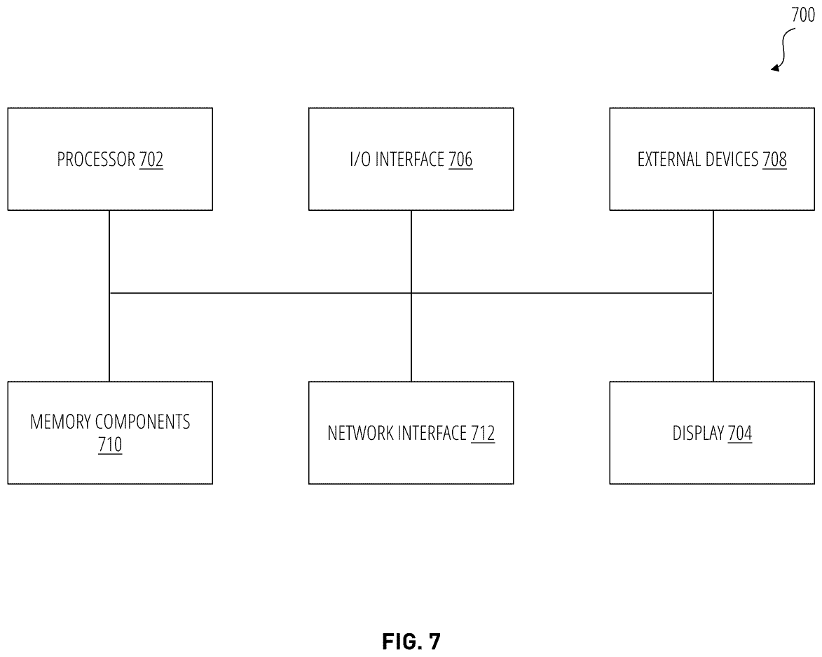

The system 100 includes a user device 106, a data store 108, a search system 112, and an educational system 114 in communication with a recommendation engine system 102 either directly or indirectly, e.g., via a network 104. In some embodiments, the recommendation engine system 102 includes a memory 118 and a processor 116. The memory 118 may include or access various types of data or instructions used by the recommendation engine system 102. Such data and instructions may include user learning journey data 120, user search data 122, search instructions 124, and content recommendation instructions 126 in various examples. Such data and instructions may be stored on and/or executed by a computing device as described with respect to FIG. 7.

The recommendation engine system 102 is accessible by a user 128 through a user interface 110 provided by the user device 106, e.g., through a software application. In some embodiments, the recommendation engine system 102 may be in communication with one or more user devices 106, one or more data stores 108, one or more search systems 112, and one or more educational systems 114. In some embodiments, the recommendation engine system 102, data store 108, search system 112, and/or educational system 114 may be incorporated into the user device 106 as an application rather than as a separate system.

In some embodiments, a user 128 may engage with the system 100 through a user device 106. In some examples, the user 128 may be an educational content consumer, such as a participant or student in an educational experience. In other examples, the user 128 may be an educational content administrator.

In some embodiments, the user device 106 may be a device utilized by a user 128. The user device 106 may communicate with the recommendation engine system 102 (e.g., via network 104). The user device 106 and network 104 are discussed in more detail with respect to FIG. 7. In some examples, the recommendation engine system 102 is executed on the user device 106. In such examples, communication between the recommendation engine system 102 and the user device 106 may not be via network 104. In some examples, a user 128 may input a request to generate a personalized search result or a personalized educational curriculum through the user interface 110. The user device 106 may communicate the request to the recommendation engine system 102. The recommendation engine system 102 may generate the personalized search result or personalized educational curriculum and display the personalized search result or personalized educational curriculum to the user 128 via the user interface 110.

In some embodiments, the recommendation engine system 102 may be in communication with a data store 108. The data store 108 may include memory storage (e.g., in a server) for storing user learning journey data 120, user search data 122, educational content items, and other such data. For example, data store 108 may be a server hosting multimedia content, such as educational videos, text documents, interactive documents, assessment documents, and the like. The data store 108 may be implemented as one storage device (e.g., physical device) or distributed across various storage devices.

In some embodiments, the recommendation engine system 102 may be in communication with a search system 112. The search system 112 may include a search engine configured to receive a search query (e.g., via user device 106), generate a search result in response to the search query, and display the search result (e.g., via user interface 110). As used herein, a search result may include indexed locations (e.g., a URL) which may link to external or internal source (e.g., an external location on the internet or an internal location on an Intranet), multimedia documents, answers to search inquiries, interactive applications, and the like.

Based on the search query, the search engine may conduct an internal search to generate a search result from data or documents internal to the system 100. For example, the search system 112 may receive a search query for an educational content item and may search the data store 108 and/or educational system 114 to generate a search result including the content item. The search system 112 may be in communication with the data store 108 and/or the educational system 114 (e.g., via the network 104) to enable searching and transferring data to and/or from the data store 108 and/or the educational system 114. The search engine may also conduct an external search to generate a search result from data stores or servers external to the system 100. For example, the search system 112 may receive a factual inquiry and may conduct an Internet or web search to generate a search result answering the inquiry.

Furthermore, the search system 112 may be configured to allow user interaction with the search result and may record a user's 128 search history and interaction with search results. For example, a user 128 may select (e.g., click via a cursor) a listed search result displayed via a user interface 110 to be directed to a page associated with the listed search result. The search system 112 may record the user's 128 search query, the search results displayed to the user 128, and the user's 128 interaction with the search results.

In some examples, the search system 112 may include virtual assistant functionality configured to provide personalized summaries of the search result and/or personalized recommendations for further search queries and/or content items for the user 128. For example, the search system 112 and/or recommendation engine system 102 may include a large language model (LLM) 130 configured with retrieval augmented generation (RAG) functionality. The search system 112 and/or recommendation engine system 102 may utilize the LLM 130 to retrieve and analyze data from a content item associated with a generated search result to generate a natural language summary of the content item.

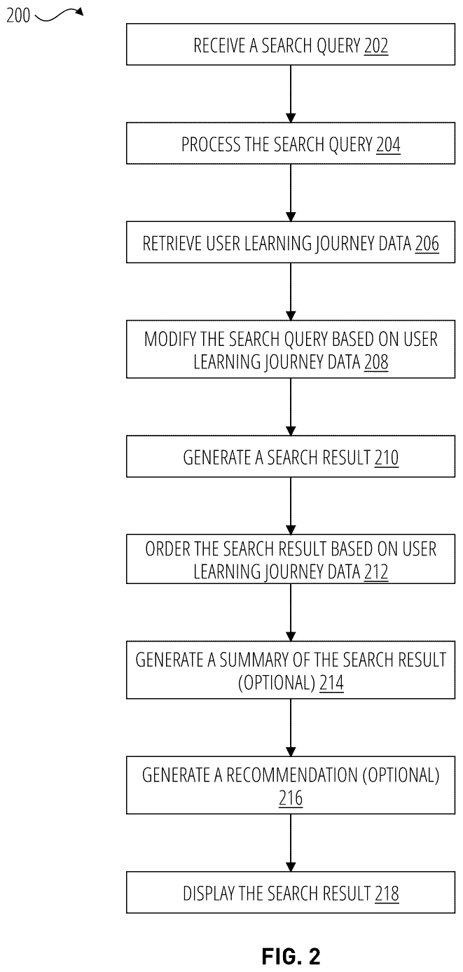

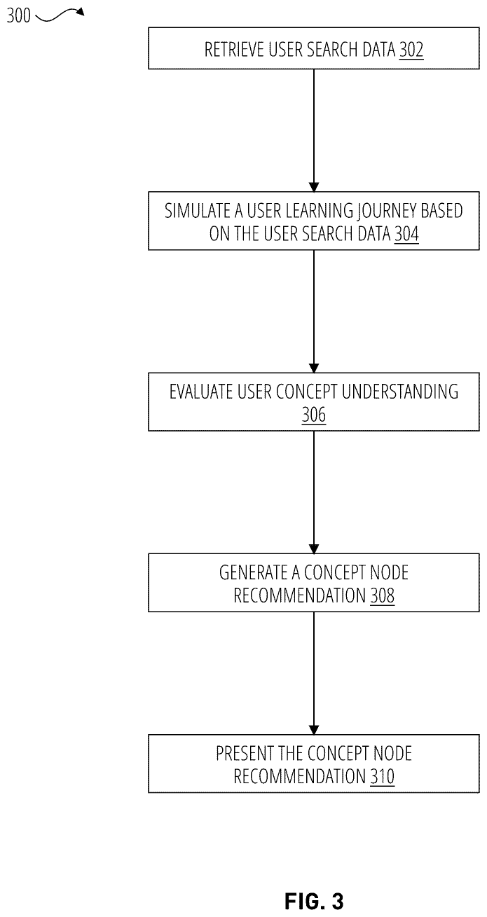

In some examples, the summary may include interactable citations that may reference a source location in the content item associated with a portion of the summary. In some examples, the citations may be configured to depict additional information related to the content item or the user 128. The citation may include a visual indicator (e.g., a symbol, a color coding, etc.) to indicate a classification, a concept, and/or a source of the content item associated with the cited portion of the summary. For example, citations referencing video content items may be presented in a different color than citations referencing text document content. In another example, the citation visual indicator may indicate the user 128 confidence and/or competency associated with concepts represented in the cited portion of the summary. For example, as described in further detail herein with reference to method 200 of FIG. 2 and method 300 of FIG. 3, the recommendation engine system 102 may assess a competency level of the user 128 related to an educational concept based on the user's 128 learning journey. Where the user 128 is assessed to have high competency in a first concept that is represented in a first content item cited in a first portion of the summary, the associated first citation may be color coded to represent high competency. Where the user 128 is assessed to have low competency in a second concept that is represented in a second content item cited in a second portion of the summary, the associated second citation may be color coded to represent low competency.

In some examples, the summary may include a visual indicator (e.g., a bounding box, highlight, etc.) indicating text of the summary to demarcate portions of the summary that are generated by the LLM 130 from portions of the summary that are directly sourced from the content item. For example, the generated summary may include a bounding box that encapsulates text generated by the LLM 130 to distinguish bounded portion of the summary from other portions of the summary that are based on and/or directly taken from a text document of the search result.

In some examples, the summary may include recommendations based on the user's 128 search history and/or learning journey. For example, the search system 112 may recommend a content item of the search result that the user 128 has not previously explored in the user's 128 learning journey and/or previous searches. In another example, the summary may recommend a content item of the search result that is likely to increase performance in a low-competency concept of the user 128.

In some examples, the search system 112 may be hosted internally by the recommendation engine system 102, and in other examples, the search system 112 may be hosted externally (e.g., on a third-party website). The search system 112 is described in further detail with reference to method 200 of FIG. 2.

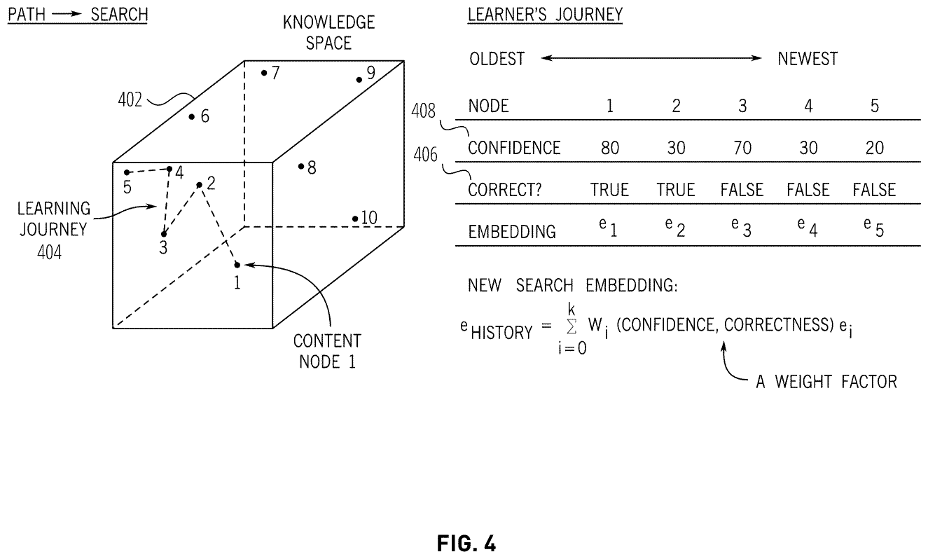

In some embodiments, the recommendation engine system 102 may be in communication with an educational system 114. The educational system 114 may be configured to deliver an educational experience to a user 128 (e.g., via user device 106). The educational system 114 may include a knowledge space, a database of curated educational content items that have been separated into concept nodes in a multidimensional concept space corresponding to different educational concepts represented in the concept nodes. For example, as portrayed in FIG. 4, the knowledge space 402 is a multidimensional concept space. Concept nodes are represented as the numbered points in the knowledge space 402. Concept nodes representing similar concepts are grouped closer together and concept nodes representing dissimilar concepts are spaced further apart. A concept node for an educational concept may include educational content items or subparts of educational content items which may be used to instruct on the educational concept. Educational content items may include multimedia files, quizzes and interactive assessments, study items, and the like. For example, a concept node for the educational concept of “mitochondria” may include text excerpts from study materials on biological cell structure, lecture videos on mitochondria with relevant timestamps, and quiz questions testing on mitochondria.

The educational system 114 may generate a personalized educational curriculum for the user 128 based on the knowledge space and the user's 128 understanding of concepts represented in the knowledge space. For example, the educational system 114 may present a content item from the knowledge space to the user 128. After the user 128 has consumed the content item, the educational system 114 may present an assessment to the user 128 to assess the user's 128 understanding of a concept present in the content item. Based on the assessment, the educational system 114 may recommend and present further content items from the knowledge space. The educational system 114 may record the learning journey of the user 128, including the content items and concepts consumed by the user 128 and the assessed understanding of the concepts presented to the user 128. In some examples, the educational system 114 may communicate with the data store 108 (e.g., via the network 104) to retrieve data, such as educational content items.

In some embodiments, the recommendation engine system 102 includes user learning journey data 120 stored e.g., on the memory 118. The user learning journey data 120 may store educational competency data of a user 128 (e.g., a student of an educational experience, such as online educational course, knowledge journey through content items, or the like) including data related to the learning journey of the user 128, such as a learning journey of the user's 128 progression through an educational curriculum provided by the educational system 114. The learning journey data 120 may include user specific data regarding evaluations of the user's 128 educational competencies for select educational concepts. For example, user learning journey data 120 may include one or more of user profile information, educational content items presented to the user 128, educational concepts presented to the user 128, assessments of the user's 128 understanding of content items and/or concepts, the progression of the user 128 through concept nodes in the knowledge space, recommendations for further content items to be presented to the user, and the like. For example, user learning journey data 120 may include an ordered list of content items consumed by the user 128, assessment scores from quizzes taken by the user 128, and/or the user's 128 self-rated confidence in the understanding of content items and/or concepts (e.g., via user inputted information via sliders, selection, or the like). As portrayed in learning journey 404 of FIG. 4, The user learning journey data 120 may include the user's 128 learning journey 404 through concept nodes one through five and user learning journey data 120 may also include concept nodes six through ten of the knowledge space 402 that represent forthcoming concept nodes that may be recommended and/or presented to the user 128 as a part of the personalized educational curriculum generated for the user 128.

The recommendation engine system 102 may receive the user learning journey data 120 from the user device 106, educational system 114, or data store 108 (e.g., via the network 104) and store the user learning journey data 120 in memory 118. The user learning journey data 120 may be dynamically updated as the user 128 progresses through an educational curriculum internal to the system 100 (e.g., an educational curriculum provided by the educational system 114) or an educational experience external to the system 100 (e.g., learning courses or online classes provided by third-party systems). For example, the user 128 may access the educational system 114 and interact with an educational content item via a user interface 110 of the user device 106. The user device 106 may communicate the user interaction with the content item to the recommendation engine system 102, which stores the user interaction as a part of the user's 128 learning journey in user learning journey data 120.

In some embodiments, the recommendation engine system 102 includes user search data 122 stored e.g., on the memory 118. The user search data 122 may store user data (e.g., a consumer of the recommendation engine experience) related to the search history of the user 128, such as a history of the user's 128 interaction with the search system 112. For example, user search data 122 may include records of one or more of search queries input by the user 128, search results displayed to the user 128, the user's 128 interaction with search results, and the like. For example, the user search data 122 may have an ordered list of search queries input by the user 128 to the search system 112.

The recommendation engine system 102 receives the user search data 122 from the user device 106, search system 112, or data store 108 (e.g., via the network 104) and stores the user search data 122 in memory 118. For example, the search system 112 may record a search query of the user 128 and communicate the search query to the recommendation engine system 102, which stores the search query in the user search data 122.

In some embodiments, the recommendation engine system 102 includes search instructions 124 stored e.g., on the memory 118. The search instructions 124 may, when executed by the processor 116, generate a personalized search result for a user 128 based on the learning journey of the user 128 (e.g., as according to method 200). The search instructions 124 may include instructions to modify a search query input by the user 128 based on the user learning journey data 120, generate a search result based on the modified search query, bias the search result based on the user learning journey data 120, and present the search result to the user (e.g., via user interface 110). The search instructions 124 are described in further detail with respect to method 200 of FIG. 2.

In some embodiments, the recommendation engine system 102 includes content recommendation instructions 126 stored e.g., on the memory 118. The content recommendation instructions 126 may, when executed by the processor 116, generate or modify a personalized educational curriculum for a user 128 based on the search history of the user 128 (e.g., as according to method 300). The content recommendation instructions 126 may include instructions to simulate a learning journey based on the user search data 122, evaluate the user's 128 understanding of a concept based on the simulated learning journey, generate a content recommendation based on the evaluation, and present the content recommendation to the user 128 (e.g., via user interface 110). The content recommendation instructions 126 are described in further detail with respect to method 300 of FIG. 3.

While the data and instructions, such as the user learning journey data 120, user search data 122, search instructions 124, and content recommendation instructions 126 are shown in FIG. 1 as being stored in the memory 118, in some examples, the data and instructions may be stored at other memory resources of the recommendation engine system 102 and/or at locations remote from the recommendation engine system 102, such as various databases or data stores (e.g., the data store 108). In such examples, the memory 118 of the recommendation engine system 102 may include instructions for accessing such data and instructions from remote locations, including, for example, the locations of the data and/or specific queries used to retrieve data for use by the recommendation engine system 102. For example, where the user learning journey data 120 is stored in the educational system 114, memory 118 may include instructions for how to retrieve or access the data from the educational system 114.

The recommendation engine system 102 may be implemented by or at a computing device or combinations of computing resources in various embodiments. In various examples, the recommendation engine system 102 may be implemented by one or more servers, cloud computing resources, and/or other computing devices. The recommendation engine system 102 may, for example, be incorporated as a module within a mobile application, software application, or a website presented through a web browser (e.g., at a laptop or desktop computer), and the like.

The components of FIG. 1 are exemplary only. In various examples, the recommendation engine system 102 may communicate with and/or include additional components and/or functionality not shown in FIG. 1. Although not shown in FIG. 1, the recommendation engine system 102 may also be in communication with other systems or components. For example, the recommendation engine system 102 may communicate with other educational systems or platforms.

FIG. 2 illustrates an example method 200 for generating a search result based on user learning journey data 120 with the recommendation engine system 102 according to an embodiment of the disclosure. The method 200 may generate a search result not only based on a search query input by a user 128, but also based on what the user 128 intends to search for or what the user 128 should search for based on the user's 128 educational competency. For example, a user 128 may intend to search for a concept with low educational competency even where the search query does not explicitly include the concept. For example, where a user 128 struggles to understand the mitochondria of a cell, when the user 128 searches for “biological cell structure,” the method 200 may generate a search result including educational content items associated with mitochondria based on the user's 128 low educational competency.

In some instances, the method 200 may be configured to use the learning journey data 120 associated with the user 128 to provide additional context, e.g., narrow the scope and details of the search parameters, to help provide more relevant results. Additionally, or alternatively, the method may be configured to predict intent or desire from the user 128 in the search results, such as by providing additional context to make the search results more relevant. For example, a user 128 may input a generic search query, but given recent learnings of the user 128, the user 128 may expect or hope to receive search results more specific to the recent learnings. By modifying the search query based on the learning journey data 120, the search results may align with expectations and/or desires of the user 128.

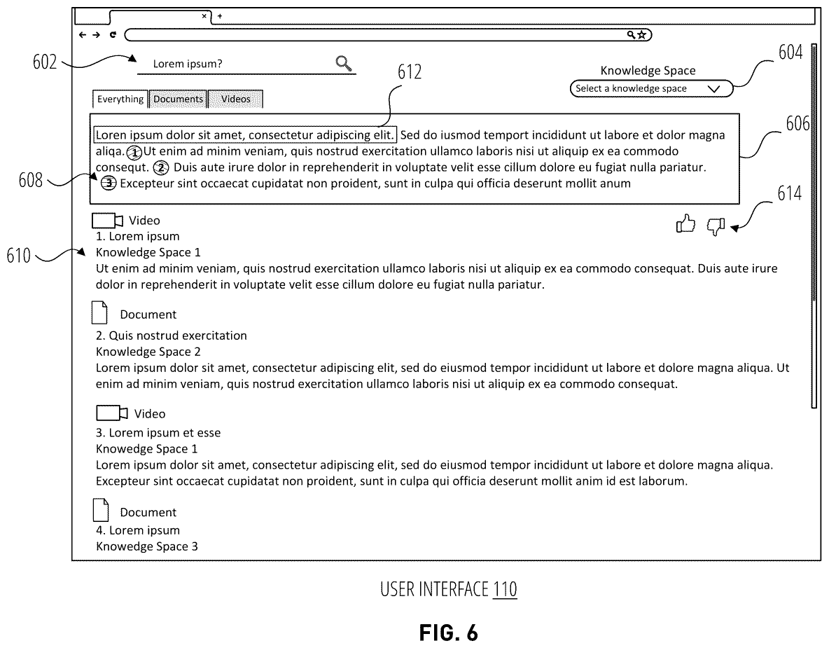

At operation 202, the recommendation engine system 102 receives a search query. The recommendation engine system 102 may receive a search query input by a user 128, e.g., via the user 128 interaction with the search system 112. The recommendation engine system 102 may receive the search query from the search system 112 or user device 106 (e.g., via the network 104). FIG. 6 portrays an example user interface 110 of the recommendation engine system 102 configured to receive a search query input and display a search result in response to the search query according to an embodiment of the disclosure. In some examples, the user 128 may interact with the search bar 602 to input a search query (e.g., by typing a text search query into the search bar 602).

The search query may include a textual search term or phrase representative an inquiry of the user 128. The search query may represent a user 128 request for the search system 112 to generate a search result in response to the search query. For example, the search query may include a question input by the user 128 for which the user 128 seeks an answer from the search system 112, e.g., “how many inches are in a foot” or “how to multiply ten times 12”. In some examples, the search query may include multimedia content such as an image, video, and/or audio file. In such examples, the search system 112 may be configured to perform a reverse image search, reverse video search, and/or reverse audio search. For example, the user 128 may upload an image to the search system 112 as a search query and the search system 112 may generate a search result disclosing the source of the image or information related to the image. The recommendation engine system 102 may store the search query in memory 118 (e.g., in user search data 122).

At operation 204, the recommendation engine system 102 processes the search query to generate a vector embedding. The vector embedding may include a textual or numerical representation of the search query, including one or more educational concepts represented or present in the search query. The vector embedding may represent the educational concepts as points in a multidimensional space, where similar educational concepts are grouped closer together in the multidimensional space, and dissimilar educational concepts are spaced further apart in the multidimensional space. For example, the vector embedding for a search query, “what are mitochondria?” may include an embedding of the educational concept of “mitochondria” and coordinates for the concept in the multidimensional space. The coordinates for “mitochondria” may be near the coordinates of similar concepts, such as “biological cell structure.”

The recommendation engine system 102 may generate a processed search query by converting the search term or phrase of the search query into a first vector embedding representation of a first concept present in the search query. In some examples, the recommendation engine system 102 may append a second vector embedding to the processed search query, e.g., where the second vector embedding represents a second concept not present in the search query but near the first vector embedding in the multidimensional space. For example, where the search query contains a concept such as the melting point of ice, the recommendation engine system 102 may append a vector embedding to the processed search query representing a similar concept in the multidimensional space, such as the boiling point of water.

At operation 206, the recommendation engine system 102 retrieves user learning journey data 120. The recommendation engine system 102 may retrieve the user learning journey data 120 from the user device 106, educational system 114, or data store 108 (e.g., via the network 104). For example, the recommendation engine system 102 may communicate with the educational system 114 to retrieve the user's 128 journey through concept nodes in the knowledge space, including the content items consumed by the user 128, the assessments taken by the user 128, forthcoming concept nodes to be presented to the user 128, evaluations of the user's 128 understanding of concepts, and the like. As shown in the example learning journey 404 in FIG. 4, the user learning journey data 120 may include the concept nodes one through five listed in the order from the oldest to newest concept nodes presented to the user 128. The user learning journey data 120 may also have a veracity evaluation 406 of the veracity of answers provided by the user 128 in response to assessments presented in each concept node and a confidence evaluation 408 of the user's 128 understanding of concepts presented in each concept node. The user learning journey data 120 may also include user inputs representing the user's 128 self-assessment of his or her own confidence level in the concepts presented in each concept node. For example, the user 128 may interact with a numerical slider displayed on the user interface 110 to indicate high or low confidence in a concept. The user device 106 may communicate the user input to the recommendation engine system 102. The recommendation engine system 102 may store the user learning journey data 120 in memory 118.

At operation 208, the recommendation engine system 102 modifies the search query based on the user learning journey data 120. The recommendation engine system 102 may modify the search query processed at operation 204 based on the user's 128 progress through concept nodes in the knowledge space and the user's 128 understanding of concepts presented in the concept nodes. In some examples, the user's 128 learning journey through concept nodes and the user's 128 understanding of concepts presented in the concept nodes, may follow the Markov property, such that the whole history of the user's 128 progression through the concept nodes may be accurately represented in the most recent concept node presented to the user and the most recent evaluation of the user's 128 understanding of concepts. For example, a learning journey may follow the Markov property where an educational curriculum has been tailored to build upon each previous concept node presented to the user 128 to iteratively increase the user's 128 understanding of an educational concept, and each concept node includes data associated with the concepts from all the previous concept nodes. In this learning journey, the most accurate representation of the user's 128 current understanding of the educational concept may be represented in the most recent concept node presented to the user 128 and the most recent assessment of the user's 128 understanding of the educational concept. In such examples, the recommendation engine system 102 may modify the search query by appending data from the forthcoming next concept node that the educational system 114 will recommend to the user. For example, in the example learning journey 404 of FIG. 4, where the user 128 has progressed through concept nodes one through five and will be recommended concept node six as the next step in the user's 128 learning journey, the recommendation engine system 102 may modify the search query by appending text of content items in concept node six to the search query. Alternatively, the recommendation engine system 102 may generate an embedding vector and/or a text embedding of concepts present in concept node six and append the embedding vector and/or text embedding to the search query.

In other examples, in addition to appending the data from concept node six to the search query, the recommendation engine system 102 may also append data from one or more of the most recent concept nodes presented to the user 128 (e.g., one or more of concept nodes one through five). In such examples, text, embedding vectors, and/or text embeddings of the one or more most recent concept nodes may be appended to the search query alongside the data of concept node six. The concept nodes' contribution towards the search query may be weighted according to how recently the user 128 consumed the concept node, evaluations of the user's 128 understanding of concepts presented in the concept node (e.g., the assessed user confidence level in concepts presented in the concept node and/or the correctness of user answers in response to assessments presented to the user 128 in the concept node), and the like. For example, where the user 128 consumed concept node five more recently than concept node four, and/or the user 128 has a higher understanding of the concepts in concept node four than the concepts in concept node five, the recommendation engine system 102 may weight the concept nodes such that more data from concept node five is appended to the search query as compared to data from concept node four. The recommendation engine system 102 may employ an algorithmic weighting function, such as shown in Eq. (1) below:

$${e}_{h istory} = {\sum }_{i = 0}^{k} {w}_{i} ( confidence , correctness ) {e}_{i} \qquad Eq . ( 1 )$$

where wᵢ represents a weight factor based on the recentness of the concept node and the user understanding of concepts presented in the concept node. In this manner, the recommendation engine system 102 modifies the search query by including concepts that the user 128 has recently consumed in the user's 128 learning journey and/or concepts that the user 128 does not proficiently understand.

At operation 210, the recommendation engine system 102 generates a search result based on the modified search query. The recommendation engine system 102 may communicate the modified search query generated at operation 208 to the search system 112 (e.g., via the network 104) to enable the search system 112 to generate a search result in response to the modified search query (e.g., by employing a search engine to search for results based on the search query). The search result may include a content item or a link to a content item, where the content item is related to the search query or responsive to an inquiry of the search query. For example, where the search query includes an inquiry for the known periodic elements, the search system 112 may generate a search result including a link to a web page displaying a periodic table. The search system 112 may communicate the search result to the recommendation engine system 102 (e.g., via the network 104).

In some examples, the recommendation engine system 102 generates the search result by searching only defined databases or sets of content items. For example, referring to FIG. 6, the user 128 may interact with the knowledge space selector 604 to select one or more knowledge spaces for a search query. The search system 112 may generate the search result by searching only the content items and nodes of the selected one or more knowledge spaces, and the search system 112 may not search databases or locations outside of the selected one or more knowledge spaces. For example, the search system 112 may not conduct a web search to generate a search result based on data available via various Internet sources. In this manner, the recommendation engine system 102 may improve the relevance, reliability, and veracity of the search result by generating the search result based only on the selected knowledge spaces. For example, since knowledge spaces are configured with curated content items, the veracity and reliability of information represented in the curated content items is likely higher than the veracity and reliability of information represented in unvetted content items available via various internet sources. By limiting search results to the curated content items of the knowledge spaces, the recommendation engine system 102 may improve the veracity and reliability of the search results. Additionally, since the one or more knowledge spaces are related to the learning journey of the user 128 and selected by the user 128, the generated search results are likely more relevant to the search query input by the user 128.

As such, the recommendation engine system 102 may also provide an improved search experience in other contexts outside of the educational and/or learning context. For example, the recommendation engine system 102 may provide an enterprise search experience in the corporate context to enable context dependent search of internal documents and data. Where a corporation has multiple clients, the recommendation engine system 102 may generate a knowledge space for each client, where each knowledge space is a multi-dimensional space configured to organize and store documents related to the associated client. By interacting with the knowledge space selector 604, the user 128 may select one or more knowledge spaces associated with one or more clients to search from.

At operation 212, the recommendation engine system 102 orders the search result based on the user learning journey data 120. Where the search result (e.g., the search result generated at operation 210) includes a plurality of content items, the recommendation engine system 102 may change the order in which the content items are displayed based on the learning journey of the user 128. For example, may order the search result to prioritize displaying a content item, where the content item includes a concept recently explored by the user 128 in the learning journey, or where the content item includes a concept that the user 128 had low confidence In. For example, where the search result contains a list of web links, the recommendation engine system 102 may order the web links to display links relevant to the user's 128 current concept node at the top of search result list and display links less relevant to the user's 128 learning journey at the bottom of the search result list.

At operation 214, the recommendation engine system 102 optionally generates a summary of the search result. The recommendation engine system 102 may utilize an LLM 130 to generate a natural language summary of one or more content items of the search result. The LLM 130 may utilize a RAG operation to retrieve and analyze data from the one or more content items to summarize the content of the one or more content items and/or the concepts represented in the one or more content items.

In some examples, the recommendation engine system 102 may extract a portion of the one or more content items based on relevance of the portion to the user's 128 search query. For example, the RAG operation may tokenize the one or more content items and generate semantic embeddings of the tokens. The RAG operation may analyze the tokens to determine semantic similarity and/or relevance of the tokens relative to the search query. The RAG operation may identify a portion of the one or more content items with high semantic similarity and/or relevance of the search query, and the RAG operation may extract the portion to summarize and/or reproduce the portion in the generated summary. In some examples, the recommendation engine system 102 may extract the portion based on the user learning journey data 120 associated with the user 128. For example, the RAG operation may extract a portion with high semantic relevance to a concept for which the user 128 has exhibited low competency during the user's 128 learning journey.

In some examples, the summary may include a natural language response to the search query input by the user 128. For example, where the search query includes a question posed by the user 128, the LLM 130 may perform a RAG operation to analyze data from the one or more content items of the search result to generate a natural language answer to the question based on and/or including data from the one or more content items.

In some examples, the recommendation engine system 102 may format the summary to include interactable citations that may reference a source content item associated with a portion of the summary. FIG. 6 portrays an example user interface 110 display of a summary 606 generated by the recommendation engine system 102 based on a search result 610 of one or more listed content items. The summary 606 includes citations 608 (i.e., the numbered citations labeled “1,” “2,” and “3”) following portions of the summary 606 that indicate the source associated with the corresponding portions of the summary 606. For example, the citation 608 labeled “1” may indicate that the preceding sentence of the summary 606 is sourced from and/or based on the first listed content item in the search result 610. The citation 608 labeled “2” may indicate that the preceding sentence of the summary 606 is sourced from and/or based on the second listed content item in the search result 610, so on and so forth.

In some examples, the citation 608 may include a visual indicator configured to indicate a classification, a concept, a user 128 competency, user learning journey data 120, user search data 122, etc. associated with the cited portion of the summary 606. For example, the citation 608 may include circles that are color coded to represent a level of user 128 competency associated with a concept represented the cited portion of the summary 606 and/or the content item of the search result 610 referenced by the citation 608. In another example, the citation 608 may be color coded based on whether the user 128 has previously interacted with the content item of the search result 610 referenced by the citation 608.

In some examples, the citation 608 may be interactable, and the user 128 may interact with the citation 608 (e.g., by clicking the citation 608 icon, hovering over the citation 608 icon, etc.) to view the cited content item of the search result 610. For example, by clicking on the citation 608 labeled “1,” the user interface 110 may navigate to a display of the first listed content item referenced by the citation 608. In some examples, the user interface 110 may be configured to navigate to a portion of the content item that is relevant to the cited portion of the summary 606. For example, where the content item is a video and the cited portion of the summary 606 was generated based on a first portion of the video, the user interface 110 may be configured to display the video starting from a time stamp corresponding to the beginning of the first portion of the video. In another example, where the content item is a text document and the cited portion of the summary 606 summarizes a first paragraph of the text document, the user interface 110 may be configured to display the text document at the first paragraph.

In some examples, the summary 606 may include a visual indicator, such as a bounding box 612 that indicate portions of the summary 606 that were generated by the LLM 130. As such, the recommendation engine system 102 may demarcate portions of the summary 606 that are generated by the LLM 130 from portions of the summary 606 that are directly sourced from and/or based on content items of the search result 610.

At operation 216, the recommendation engine system 102 optionally generates a recommendation to the user 128 based on the user learning journey data 120 and/or user search data 122. For example, the recommendation engine system 102 may analyze the user's 128 competency levels, confidence levels, learning journey, search history, and/or the like to recommend engagement with a content item associated with a concept that the user 128 has a high competency in but has not reviewed recently, to recommend engagement with a content item associated with a concept that the user 128 has reported low confidence in, to recommend a content item the user 128 has not previously engaged in, to recommend a content item that is likely to improve competency in a concept based on the user 128 learning journey and/or the learning journey of other users 128 engaged with the recommendation engine system 102, to recommend a content item associated with a concept adjacent to concepts previously explored by the user 128, to recommend search terms for future search queries, to recommend popular search queries based on the user 128 search history and/or the search history of other users 128 engaged with the recommendation engine system 102, and/or the like.

In some examples, the recommendation engine system 102 may incorporate the recommendation as an element of the summary 606 or search result 610. For example, the summary 606 may include a natural language text string generated by the LLM 130 that summarizes the recommendation to the user 128. In another example, the search result 610 may include visual indicators highlighting recommended content items.

At operation 218, the recommendation engine system 102 presents the search experience to the user 128 by displaying the generated search result, summary, and/or recommendation to the user 128 via the user interface 110. The recommendation engine system 102 communicates the search result (e.g., the search result ordered at operation 212), the summary, and/or the recommendation to the user device 106. The search result, summary, and/or recommendation may be displayed to the user 128 via a user interface 110 that allows the user 128 to interact with elements of the search result summary, and/or recommendation. For example, the search result may be displayed in a web page as a list of web links that the user may click to access content items.

As described above, FIG. 6 portrays an example user interface 110 configured to display the search result 610, summary 606, and/or recommendation to the user 128 via the user device 106. The search result 610 display may display information of each content item of the search result 610, including the name of the content item, the classification or content type of the content item (e.g., video, audio, text), the knowledge space where the content item is located, generated summaries of the content item relevant to the search query, and/or the like. In some examples, the content items of the search result 610 may be displayed in an ordered list based on relevance of each content item to the search query.

In some examples, the recommendation engine system 102 may receive user 128 feedback related to the presented search experience. For example, the user interface 110 may include a feedback input element 614 (e.g., a thumbs-up and thumbs-down input element, a numerical rating input element, a star rating input element, etc.) configured to receive user 128 feedback related to the user's 128 assessment of the summary 606 and/or search result 610. In another example, the recommendation engine system 102 may record user 128 feedback by recording user 128 interaction with the search experience. For example, the recommendation engine system 102 may record the search query, the generated summary 606 and search result 610, the content items that the user 128 engaged with, the length of time that the user 128 engaged with the content items, the change in competency or confidence following the engagement with the content items, the position of the user 128 in the learning journey, and/or the like. The recommendation engine system 102 may analyze the user 128 feedback to assess and improve the quality of the search experience, to assess concept competencies of the user 128 (e.g., for report to an administrator), to modify the learning journey of the user 128 (e.g., as described in further detail with respect to method 300 of FIG. 3), and/or the like.

FIG. 3 illustrates an example method 300 for generating a concept node recommendation based on user search data 122 according to an embodiment of the disclosure. In operation 302, the recommendation engine system 102 retrieves user search data 122. The recommendation engine system 102 may retrieve user search data 122 from the user device 106, data store 108, and/or search system 112 (e.g., via the network 104). The user search data 122 may include search history data of a user 128, such as a search query input by the user in the search system 112, a search result displayed to the user 128, a record of the user's 128 interaction with the displayed search result, the content items of the search result, and the like. For example, the recommendation engine system 102 may communicate with the search system 112 to retrieve a record of the web links that the user 128 clicked on when conducting a web search with the search system 112. The user search data 122 may also have time stamps marking the time of each event. In the search history data. The recommendation engine system 102 may store the user search data 122 in memory 118.

In operation 304, the recommendation engine system 102 simulates a learning journey of the user 128 based on the user search data 122. The recommendation engine system 102 may simulate a concept node based on the user's 128 search history data and insert the concept node as the most recent node explored by the user 128 in the user's 128 learning journey through the knowledge space. The recommendation engine system 102 may contextualize the search history data, such as a search query of the user 128, a search result displayed to the user 128, and/or an interaction of the user 128 with a search result, to determine an educational concept represented in the search history data. For example, the recommendation engine system 102 may employ a large language model (LLM) 130 to summarize the text of the search history data. In some examples, the LLM 130 may additionally access the content items that the user 128 has interacted with in the user's 128 search history to summarize the text of the content items.

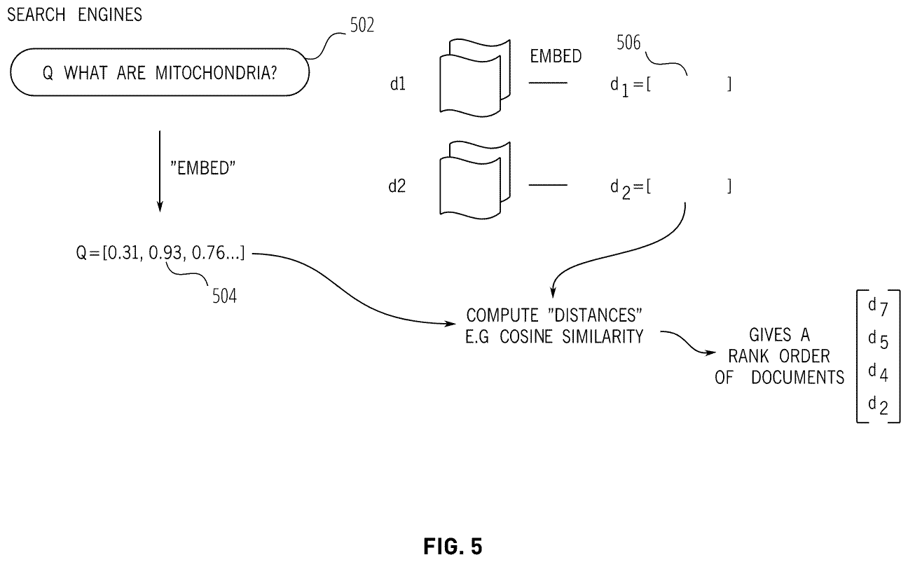

The recommendation engine system 102 may use the summary generated by the LLM 130 to determine concepts present in the search history data. For example, as portrayed in FIG. 5, where the user 128 input “What are mitochondria?” as a search query 502 in the search system 112 and interacted with the search result to click on links leading to documents d1 and d2, the recommendation engine system 102 may employ an LLM 130 to summarize the text of documents d1 and d2. The recommendation engine 102 may determine educational concepts present in documents d1 and d2 based on the LLM 130 summary. The recommendation engine system 102 may also determine educational concepts present in the search query. The recommendation engine system 102 may generate a vector embedding representing a concept of the search history data. For example, the recommendation engine system 102 may generate vector embedding 504 representing a concept of the search query 502 vector embeddings 506 representing a concept of documents d1 and d2. The recommendation engine system 102 may simulate a concept node in the knowledge space based on the concept, the vector embedding, and the search history data and modify the user learning journey data 120 based on the simulated concept node. For example, the recommendation engine system 102 may simulate a concept node on the concept of “mitochondria” based on the user's 128 search history data and modify the user's 128 learning journey to indicate that the user 128 has explored the concept of “mitochondria” as the most recent concept node in the user's 128 progression through concept nodes.

In operation 306, the recommendation engine system evaluates the user's 128 understanding of a concept based on the simulated user journey and user search data 122. The recommendation engine system 102 may evaluate the user's 128 understanding of a concept presented in the simulated concept node (e.g., the concept node simulated at operation 304). The recommendation engine system 102 may assign a low user confidence or understanding to the concept presented in the simulated concept node to reflect the user's 128 lack of confidence in the concept. For example, the user 128 may have searched the “What are mitochondria?” In the search system because the user 128 did not understand the concept of “mitochondria.” The recommendation engine system 102 may assign a low understanding of the simulated concept node representing “mitochondria” in the user's 128 learning journey. The recommendation engine system 102 may employ a mathematical decay function to evaluate the user understanding such that the more times the user 128 searches for a concept in the search system 112, the lower the assessed user confidence is in the concept.

In some examples, a concept of the simulated concept node may be assigned a low user understanding and/or confidence in the same manner as if the user 128 had answered a question on the concept incorrectly in an assessment. The recommendation engine system 102 may concatenate text from the search history data to represent a question that the user 128 answered incorrectly in the user's 128 learning journey. In another example, the recommendation engine system 102 may employ an LLM 130 to summarize the contents of the search history data as a question that the user 128 answers incorrectly in the user's 128 learning journey. For example, the recommendation engine system 102 may generate the question “what are mitochondria?” based on the user's 128 search history data and indicate in the simulated concept node that the user 128 answered the question incorrectly.

In operation 308, the recommendation engine system 102 and/or the educational system 114 generates a concept node recommendation based on the evaluation of the user 128 understanding. The recommendation for a concept node includes educational content items and/or assessments, to be presented next to the user 128 based on the user 128 understanding of a concept presented in the simulated concept node (e.g., the concept understanding assessed from the user search data 122 at operation 306). For example, where the user 128 is assessed to have low understanding in a first concept, the recommendation engine system 102 may recommend a concept node with educational content items on the first concept to further bolster the user's 128 understanding of the first concept. In other examples, where the first concept is a narrower sub-concept of a larger second concept that the user 128 has been exploring in the learning journey, the recommendation engine system 102 may recommend a concept node that that increases the specificity of content items presented to the user from the larger second concept such that the recommended concept node includes content items related to the first concept. For example, as portrayed in FIG. 5, the recommendation engine system 102 may utilize the vector embedding 504 of the search query 502 and the vector embeddings 506 of the documents d1 and d2 to generate a list of documents to recommend to the user 128 in a new concept node, where the list of documents include concepts near to the vector embedding 504 and vector embeddings 506 in the multidimensional concept space. The recommendation engine system 102 may rank the list of documents based on the proximity of the documents in the multidimensional concept space and may recommend one or more documents of the list of documents to the user in the generated concept node recommendation based on the ranking of the document.

In some examples, the educational system 114 has already established a curriculum for the user 128 including forthcoming concept nodes for the user 128 to explore. For example, the concept nodes six through ten portrayed in FIG. 4 represent concept nodes that the user 128 has yet to explore but is anticipated to do so further on in the learning journey. In such examples, the recommendation engine system 102 may insert a concept node in the curriculum based on the user's 128 concept understanding assessed from the user's 128 search history. In other examples, the recommendation engine system 102 may modify a forthcoming concept node to include content items or concepts based on the user's 128 concept understanding assessed from the user's 128 search history.

In operation 310, the concept node recommendation is presented to the user 128. The recommendation engine system 102 may transmit the concept node recommendation, including educational content items and/or assessments, to the user device 106 (e.g., via the network 104) to be displayed to the user 128 on the user interface 110. The user interface 110 may be configured to allow the user 128 to view and interact with the concept node and engage with a concept presented in the concept node.

FIG. 7 illustrates a block diagram of an example computer system suitable for use in embodiments disclosed herein according to an embodiment of the disclosure. For example, the recommendation engine system 102 may include or utilize one or several computing systems 700, and the processor 116 and memory 118 may be located at one or several computing systems 700. In various embodiments, the search system 112 and educational system 114 are implemented by a computing system 700. In various implementations, the user device 106 and/or additional user devices may be implemented using any number of computing devices including, but not limited to a computer, laptop, tablet, mobile phone, smart phone, wearable device (e.g., AR/VR headset, smartwatch, smart glasses, or the like), smart speaker, vehicle (e.g., automobile), or appliance.

This disclosure contemplates any suitable number of computing systems 700. For example, the computing system 700 may be a server, a desktop computing system, a mainframe, a mesh of computing systems, a laptop or notebook computing system, a tablet computing system, an embedded computer system, a system-on-chip, a single-board computing system, or a combination of two or more of these. Where appropriate, the computing system 700 may include one or more computing systems; be unitary or distributed; span multiple locations; span multiple machines; span multiple data centers; or reside in a cloud, which may include one or more cloud components in one or more networks. The computing system 700 may include one or more processors 702, an input/output (I/O) interface 706, one or more external devices 708, one or more memory components 710, and a network interface 712. Each of the various components may be in communication with one another through one or more buses or communication networks, such as wired or wireless networks.

In some embodiments, various components of the computing system 700 may communicate with one another through the network 104. For example, in some embodiments, the computing system 700 may be implemented as a serverless service, where computing resources for various components of the computing system 700 may be located across various computing environments (e.g., cloud platforms) and may be reallocated dynamically and/or automatically according to, for example resource usage of the computing system 700. In various implementations, the computing system 700 may be implemented using organizational processing constructs such as functions implemented by worker elements allocated with compute resources, containers, virtual machines, and the like.

The processor 702 may be any type of electronic device capable of processing, receiving, and/or transmitting instructions. For example, the processor 702 may be a central processing unit, graphics processing unit, microprocessor, processor, or microcontroller. Additionally, it should be noted that some components of the computing system 700 may be controlled by a first processor and other components may be controlled by a second processor, where the first and second processors may or may not be in communication with each other. The search system 112, educational system 114, and user device 106 may perform operations by executing executable instructions (e.g., software) using the processor 702. The processor 702 may be used to implement processor 116 shown in FIG. 1.

The I/O interface 706 allows a user to enter data in to computing system 700, as well as provides an input/output for the computing system 700 to communicate with other devices or services. The I/O interface 706 can include one or more input buttons, touch pads, and so on.

The external devices 708 are one or more devices that can be used to provide various inputs to the computing system 700, e.g., mouse, microphone, keyboard, trackpad, or the like. The external devices 708 may be local or remote and may vary as desired. In some examples, the external devices 708 may also include one or more additional sensors.

The memory components 710 are used by the computing system 700 to store instructions for the processor 702 and may be implemented as a data store and the like. The memory components 710 may be, for example, magneto-optical storage, read-only memory, random access memory, erasable programmable memory, flash memory, or a combination of one or more types of memory components. The memory components 710 may be used to implement the memory 118 shown in FIG. 1. The memory 118 may include various instructions for various functions of the recommendation engine system 102 which, when executed by the processor 116, perform various functions of the recommendation engine system 102. The memory 118 may further store data and/or instructions for retrieving data used by the recommendation engine system 102. Similar to the processor 116, the memory 118 utilized by the recommendation engine system 102 may be distributed across various physical computing devices. In some examples, the memory 118 may access instructions and/or data from other devices or locations, and such instructions and/or data may be read into memory 118 to implement the recommendation engine system 102.

The network interface 712 provides communication to and from the computing system 700 to other devices. The network interface 712 includes one or more communication protocols, such as, but not limited to WI-FI®, Ethernet, BLUETOOTH®, and so on. The network interface 712 may also include one or more hardwired components, such as a Universal Serial Bus (USB) cable, or the like. The configuration of the network interface 712 depends on the types of communication desired and may be modified to communicate via WIFI®, BLUETOOTH®, and so on.

The network interface 712 may interface with the network 104. The network 104 may be implemented using one or more wired and/or wireless systems and protocols for communications between computing devices. In various embodiments, the network 104 or various portions of the network 104 may be implemented using the internet, a local area network, a wide area network, and/or other networks. In addition to traditional data networking protocols, in some embodiments, data may be communicated according to protocols and/or standards including near field communication, Bluetooth®, Wi-Fi, cellular connections, or the like.

The display 704 provides a visual output for the computing devices and may be varied as needed based on the device. The display 704 may be configured to provide visual feedback to the user and may include a liquid crystal display screen, light emitting diode screen, plasma screen, or the like. In some examples, the display 704 may be configured to act as an input element for the user through touch feedback or the like.

The components in FIG. 7 are exemplary only. In various examples, the computing system 700 may include additional components and/or functionality not shown in FIG. 7.

Accordingly, the recommendation engine system 102 described herein addresses particular challenges and needs presented by educational systems and search systems. For example, educational systems often only measure the competency of a student based on the student's engagement with the prescribed curriculum. The recommendation engine system 102 described herein evaluates the student's competency based on the student's search history in order to provide a more personalized educational experience that is better tailored to address the strengths and weaknesses of the student. Furthermore, search systems often only provide search results based on the search query input by a user. The recommendation engine system 102 described herein evaluates the learning journey of the user to determine what concepts the user is struggling with and likely to search in order to provide a personalized search experience that generates search results that better address the user's search query and needs. By integrating the educational system 114 and the search system 112, the recommendation engine system 102 is able to incorporate data from both systems to generate both an improved educational experience and an improved search experience.

The technology described herein may be implemented as logical operations and/or modules in one or more systems. The logical operations may be implemented as a sequence of processor-implemented steps directed by software programs executing in one or more computer systems and as interconnected machine or circuit modules within one or more computer systems, or as a combination of both. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

The description of certain embodiments included herein is merely exemplary in nature and is in no way intended to limit the scope of the disclosure or its applications or uses. In the included detailed description of embodiments of the present systems and methods, reference is made to the accompanying figures which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The Included detailed description therefore=not to be taken in a limiting sense, and the scope of the disclosure Is defined only by the appended claims.

From the foregoing it will be appreciated that, although specific embodiments of the invention have been described herein for purposes of illustration, various modifications may be made without deviating from the spirit and scope of the invention.

Although the methods described herein (e.g., method 200 and method 300) depict a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

The particulars shown herein are by way of example and for purposes of illustrative discussion of the preferred embodiments of the present disclosure and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the figures and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

All relative, directional, and ordinal references (including top, bottom, side, front, rear, first, second, third, and so forth) are given by way of example to aid the reader's understanding of the examples described herein. They should not be read to be requirements or limitations, particularly as to the position, orientation, or use unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and Intended spirit and scope of the present system as set forth in the claims that follow. Accordingly, the specification and figures are to be regarded in an illustrative manner and are not intended to limit the scope of the appended claims.

What is claimed is:

1. A computer implemented method for generating personalized search results, the method comprising:
processing, via a processor, a search query of a user;
modifying, via the processor, the search query based on educational competency data of the user;
generating, via the processor, a search result based on the modified search query by performing a search operation in a knowledge space based on the modified search query to retrieve one or more content items of the knowledge space corresponding to the modified search query;
generating, via the processor, a user interface configured to display the search result; and
transmitting, via the processor, the user interface to a user device associated with the user.

2. The computer implemented method of claim 1, wherein processing the search query comprises generating an embedding vector from search terms of the search query.

3. The computer implemented method of claim 2, wherein the embedding vector comprises a text embedding of the search terms and a text embedding of terms similar in meaning to the search terms.

4. The computer implemented method of claim 1, wherein the educational competency data comprises learning journey data, educational content data, assessment data, and content recommendation data, and wherein modifying the search query based on the educational competency data of the user comprises:
retrieving a last content recommendation of a learning journey of the user;
generating a text embedding of the last recent recommended content; and
appending the text embedding to the search query.

5. The computer implemented method of claim 1, wherein the educational competency data comprises learning journey data, educational content data, assessment data, and content recommendation data, and wherein modifying the search query based on the educational competency data of the user comprises:
retrieving a plurality of content recommendations of a learning journey of the user;
generating a text embedding of the plurality of recommended content; and
appending the text embedding to the search query.

6. The computer implemented method of claim 5, wherein appending the text embedding to the search query comprises:
evaluating a user competency in a plurality of concepts presented in the plurality of recommended content;
determining a concept with low user competency; and
appending a text embedding corresponding to the concept with low user competency to the search query.

7. The computer implemented method of claim 1, further comprising generating a summary based on the search result, comprising:
generating a first text portion via a large language model (LLM) utilizing a retrieval augmented generation operation to extract and summarize information of a first content item of the one or more content items;
generating a second text portion via the LLM, the second text portion comprising a natural language response to the search query based on the one or more content items;
generating a visual indicator configured to demarcate the first text portion and the second text portion;
generating a citation associated with the first text portion, wherein the citation is configured to reference the first content item; and
configuring the user interface to display the first text portion, the second text portion, the visual indicator, and the citation.

8. The computer implemented method of claim 1, wherein generating the user interface comprises:
evaluating a user competency in a plurality of concepts presented in a learning journey;
weighting the plurality of concepts such that the concepts with lower user competency are assigned a higher weight; and
configuring the user interface to display a plurality of content items of the search result based on the assigned weights.

9. The computer implemented method of claim 8, wherein configuring the user interface to display the plurality of content items of the search result based on the assigned weight comprises:
determining a concept presented in the plurality of content items of the search result;
assigning a priority to a content item of the plurality of content items based on the concept presented in the content item, such that a content item with a concept of higher weight is assigned a higher priority; and
configuring the user interface to display the content item in a ranked order based on the assigned priority.

10. The computer implemented method of claim 9, wherein generating the user interface comprises:
ordering the content items of the search result based on the assigned priority of the content items; and
configuring the user interface to display the content items of the search result to the user such that the content item with the highest assigned priority is displayed first to the user.

11. A computer implemented method for generating personalized content recommendations, the method comprising:
simulating, via a processor, educational competency data of a user based on search data of the user;
evaluating, via the processor, a user understanding of a concept based on the simulated educational competency data;
generating, via the processor, a content recommendation based on the user understanding;
generating, via the processor, a user interface configured to display the content recommendation; and
transmitting, via the processor, the user interface to a user device associated with the user.

12. The computer implemented method of claim 11, wherein the search data of the user comprises a search query of the user and a search result presented to the user.

13. The computer implemented method of claim 11, wherein the search data of the user further comprises a search result browsing history of the user, wherein the search result browsing history comprises a record of an interaction of the user with a search result.

14. The computer implemented method of claim 11, wherein the educational competency data comprises learning journey data, educational content data, assessment data, and content recommendation data, and wherein simulating the educational competency data of the user based on search data of the user comprises:
generating a learning journey node based on the search data; and
concatenating the learning journey node to a learning journey of the user.

15. The computer implemented method of claim 14, wherein generating the learning journey node based on the search data comprises:
generating a text embedding of the search data;
determining a concept represented in the text embedding; and
generating a learning journey node indicating low user competence in the concept.

16. The computer implemented method of claim 15, wherein generating the text embedding of the search data comprises concatenating a text embedding of a search query with a text embedding of a search result browsed by the user.

17. The computer implemented method of claim 15, wherein generating the text embedding of the search data comprises:
generating a summary of the search data using a language model; and
generating a text embedding of the summary.

18. The computer implemented method of claim 11, wherein evaluating the user understanding of the concept based on the simulated educational competency data comprises employing a mathematical function such that increased frequency of search data on a first concept corresponds to a lower user understanding of the first concept.

19. The computer implemented method of claim 18, wherein the mathematical function is a logarithmic decay function.

20. The computer implemented method of claim 11, wherein generating the content recommendation based on the user understanding comprises generating a recommendation for a content item corresponding to a first concept wherein the user understanding of the first concept is low.
